(19) United States
(12) Patent Application Publication
(10) Pub. No.: US 2012/0323587 A1
(43) Pub. Date: Dec. 20, 2012

(54) SYSTEMS AND METHODS FOR ESTIMATING THE SALES PRICE OF A PROPERTY

(76) Inventor: Frank Borges LLOSA, Falls Church, VA (US)

(21) Appl. No.: 13/525,743

(22) Filed: Jun. 18, 2012

Related U.S. Application Data
(60) Provisional application No. 61/498,219, filed on Jun. 17, 2011.

(51) Int. Cl. G06Q 50/16

(52) U.S. Cl. 705/1.1

(57) ABSTRACT

A sale price of a property is estimated based on the listed sale price, and information about previous sales which have been made by the seller, and/or a listing agent responsible for selling the property, and/or a firm that employs the listing agent. The information used to make an estimate may include the original listing price and the ultimate sale price for previous sales. The time at which the property is likely to sell may also be estimated.

This application claims the benefit of the filing date of provisional application Ser. No. 61/498,219, which was filed on Jun. 17, 2011, the contents of which are incorporated herein by reference.

### BACKGROUND OF THE INVENTION

The invention is related to systems and methods for estimating the price at which a property offered for sale will sell. In some instances, the property is real estate. In other instances, the property could be items other than real estate.

Most of the existing systems and methods which estimate a property's value use a valuation model that takes into account both historic data and data on the property itself. In the case of real estate, the historic data could include tax assessments and past sales of nearby similar properties. Data on the property could include the size or square footage of the property, a number of rooms, distance to city or business centers, and various other criteria. Unfortunately, those valuation models often prove unreliable, in part because the models cannot take into account all of the myriad of factors that determine a property's actual market value.

### BRIEF DESCRIPTION OF THE DRAWINGS

FIG. 1 is a diagram of a sale price estimating system which can practice the disclosed technology;

FIG. 2 is a flowchart illustrating a generalized method according to the disclosed technology of estimating the sale price of a property according to the disclosed technology;

FIG. 3 is a flowchart illustrating a method according to the disclosed technology for generating advice about how to treat a buyer's offer to purchase a property block;

FIG. 4 is flowchart illustrating a method according to the disclosed technology for conducting a pricing competition to obtain information which can be used to estimate a sales price of a property;

FIG. 5 is a flowchart illustrating a method according to the disclosed technology for estimating when a property will sell; and

FIG. 6 is a flowchart illustrating a method according to the disclosed technology for providing potential purchasers with notification regarding when a property is likely to sell.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

The following description relates to various activities which can be conducted to provide potential purchasers and potential sellers with information about the sale of a particular property. The property could be real estate, such as land, a house, a townhouse, a condominium, a commercial building or establishment, or any other form of real estate. The property could also be something other than real estate.

For the purposes of the following discussion, the disclosed technology will be discussed in connection with the sale of a piece of real estate, such as a residential home. However, it is to be understood that the disclosed technology is equally applicable to other types of property.

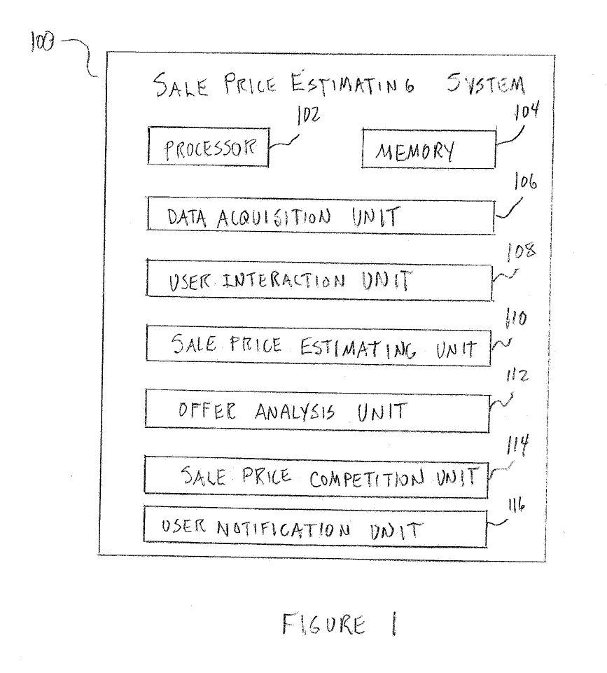

FIG. 1 illustrates elements of a sale price estimating system 100 for estimating the price at which a property will sell. The basic elements of the sale price estimating system 100 are discussed in detail below. However, before discussing the elements that make up the sale price estimating system 100, its purposes and functions will be explained.

The sale price estimating system is designed to estimate the future sales price of a specific property that is currently on the market for sale. The prediction can be a specific amount, or a range, and it can be for either a price if the home sold today, or what the home will likely sell for in the future. The system may also estimate the likelihood that the property will sell within a predetermined period of time. When a potential purchaser makes an offer to purchase a property, the system can also provide the seller with guidance about how to treat the potential buyer's offer. More specifically, the system can estimate the likelihood that the potential purchaser would respond positively to a counter-offer, and provide guidance about what the counter-offer should contain.

There are several Automated Valuation services on the market which attempt to provide buyers and sellers with information about the market value of individual properties. These valuation services use a valuation model that takes into account both historic data and data on the property itself. Historic data might include tax assessments and past sales of similar nearby properties. Data on the home could include the number of bedrooms, square footage, distance from the metro or business center, and other characteristics of the property itself. Those valuation models have proven to be unreliable and oftentimes provide value estimates that differ greatly from a property's true market value.

The sale price estimating system 100 illustrated in FIG. 1 is configured to obtain information from one or more individuals who have put significant effort into determining the starting or asking price for a property. In some instances, the individual could be the listing agent who is representing the seller. In other instances the individual could be the seller. In other instances, the individual could be someone who is unconnected to the sale of the property, but who is nevertheless capable of providing an accurate estimate of the ultimate sale price of the property. Information obtained from one or more of those individuals is then used to estimate a sale price for the property.

The sale price estimating system 100 can provide multiple and different types of predictions. For example, the system could predict the sale price for a property if the sale was made today, as well the sale price that will likely occur when the home is ultimately sold. The system may take into account the number of days that a property has been on the market, average sale prices versus list prices in the area, and the price point for a property. The system may also take into account the listing agent's past performance in selling properties quickly, and the listing agent's history with respect to the relationship between the original listing price and the ultimate sale price. The system might also take into account the listing real estate firm's past performance with respect to these and other factors.

For example, assume a first house is for sale with an original list price of $500,000. Assume also that the home has been on the market 30 days, and the listing agent's previous sales show that the agent's average sales take 90 days to close and the agent's average (or median) ratio of list price to sold price is 90%. Based on this information, the sale price estimating system could come up with two estimates.

The first estimate is for the anticipated sale price if the house were sold today. That number would be calculated from a mixture of historic data and agent data points, and the estimate might be $472,000.

The second estimate is for the anticipated sale price if the sale runs its typical course, selling approximately 90 days after it is listed. This second number could be $450,000, which is 90% of the original list price.

Now, assume a second home is also on the market, also with an original list price of $500,000. The second home, however, has been on the market only 2 days. Assume further that the listing agent tends to sell homes for 102% of the original listing price if sold within the first week. However, the agent only makes a sale within one week 25% of the time.

Under this different set of facts, the sale price estimating system 100 would provide a first estimate of the anticipated sale price if the home were sold today of $510,000. The system would also provide an estimate for the situation where the home is not sold immediately, and that estimate could be an ultimate sale price of $475,000.

As illustrated above, depending on the facts surrounding a sale, the estimate for the sale price can very considerably for two homes that are originally listed for the same price. The difference occurs because the sale price estimating system is using information about the listing agent's past performance in pricing a property to predict what the sale price will be.

The sale price estimating system 100 includes one or more processors 102 which are coupled to memory 104. Software for performing methods of calculating sale price estimates would be stored in the memory, or in external memory accessible to the processors. The processors would utilize the software to generate various items of information relating to property sales.

The sale price estimating system 100 includes a data acquisition unit 106 that obtains information used to generate estimates. That information that is obtained by the data acquisition could include a great many different things, and the information could be acquired from a large number of different sources.

The sale price estimating unit 100 also includes a user interaction unit 108. The user interaction unit provides users with an interface which can be used to request various items of information about property sales. The interface could be provided over the Internet via a web browser, or via an application running on a mobile computing device. In other instances, the user interface provided by the user interaction unit 108 could be implemented in other ways.

The sale price estimating system 100 also includes a sale price estimating unit 110. The sale price estimating unit would utilize data obtained by the data acquisition unit to provide various estimates. As discussed above, the sale price estimating unit could provide estimates of the ultimate sale price of a property, as well as an estimated sale price if the property sold today. The sale price estimating unit 110 could also provide an estimate about when a property is likely to sell. This estimate could be in the form of a percentage likelihood that a property will sell within a stated period of time. The sale price estimating unit could also provide a variety of other information, as will be discussed in greater detail below.

The sale price estimating system 100 also includes an offer analysis unit 112. The offer analysis unit utilizes data obtained by the data acquisition unit 106 to provide a seller with guidance about how to treat a potential buyer's offer to purchase a property. The specific items of information that can be provided to a seller are discussed in greater detail below.

The sale price estimating unit also includes a sale price competition unit 114, which is configured to conduct competitions in order to help obtain information which can be used by the sale price estimating unit 110 and the offer analysis unit 112 to provide estimates and guidance to potential buyers and sellers. The functions performed by the sale price competition unit are discussed in greater detail below.

Finally, the sale price estimating system 100 also includes a user notification unit 116, which provides various notifications to users regarding properties that are currently for sale, or regarding potential future sales or purchase opportunities, as is discussed in greater detail below.

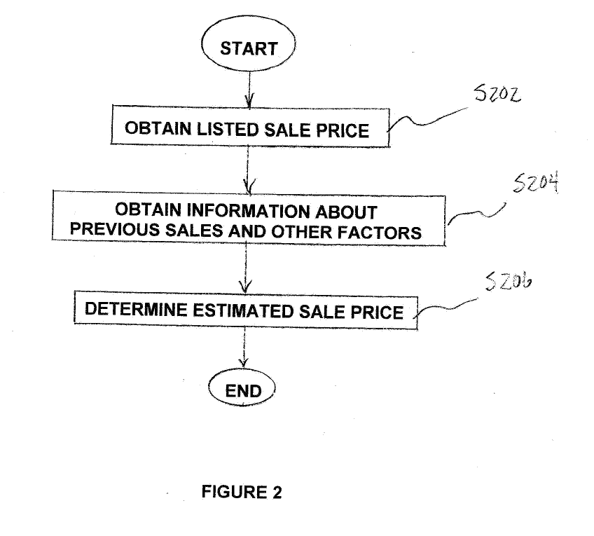

A generalized method of estimating a sale price of a property, which would be performed by elements of the sale price estimating system 100, is illustrated in FIG. 2. As shown therein, the method begins in step S202, where the current listed sale price for a property is obtained. Next, in step S204, information about previous sales involving either the seller or the seller's listing agent is obtained. Step 204 may also include obtaining information about a variety of other factors, as will be discussed in detail below. Steps S202 and S204 would be performed by the data acquisition unit 106 of the sale price estimating system 100.

The information obtained in step S204 could include information about previous sales made by the same seller. This information could include the original listing price and the ultimate sale price for one or more previous sales made by the seller. The information could include all previous sales made by the seller, or only sales of similar properties, or sales in the same area as the property currently for sale.

The information obtained in step S204 could also include information about previous sales made by the listing agent. Here again, this could include information about the original listing price and the ultimate sale price for one or more sales that were previously handled by the listing agent. The information could include all previous sales handled by the agent, or only sales handled by the agent for similar properties, or sales handled by the agent for properties in the same area or price range as the property currently for sale.

The information obtained in step S204 could also include information about the listing price and sale price for previous sales made by the real estate company that employs the agent. Here again, this information could be for all sales made by the company, only sales of similar properties, and/or only sales for properties in the same area or price range as the property currently for sale. Further, the information about the listing price and the sale price might be obtained for all listing agents in the area, not just the ones that work for the same firm as the listing agent.

The information obtained in step S204 could also include demographic information about the seller's characteristics. For example, the information could include the age and occupation of the seller, the seller's annual income, the seller's net worth, and other information about the seller's financial condition. The information could also include the seller's relationship status, ethnicity, or other distinguishing information. Virtually any information regarding the seller might be obtained in step S204 and used in step S206 to estimate the ultimate sale price of the property. All of this information could be indicative of how the seller will react to negotiations surrounding the sale of the property, and thus may provide insight regarding the ultimate sale price of the property.

The information obtained in step S204 could also include information about the listing agent. For example, the information could include the number of years of experience the agent has at selling property, and/or the number of years of relevant experience in selling other similar properties, or other properties in the same location as the property. The information could include the agent's historical record with respect to the initial offer price and the ultimate sale price for all previous sales, sales in the last year, or sales over the previous few months. The information could be specific to all property, all similar properties, or only properties in the same general area. Virtually any item of information about the agent could be obtained in step S204 and used in step S206 to estimate the ultimate sale price of the property.

The information obtained in step S204 could also include information about the property listing that is provided to potential purchasers. For example, the information could include the number of photos or videos that are posted to an online listing, and/or information regarding the length and type of any written descriptions. The information obtained in step S204 could also include information about the number of open houses that have been conducted, the number of times the property has been shown to potential purchasers, the number of times that potential purchasers have downloaded or viewed an online listing and/or the number of times that potential purchasers have saved or downloaded information from an online listing. The information could also include whether keywords appear in an online listing or other descriptions that are provided to potential purchasers, and the type and relative size of a commission that is offered to a buyer's agent for a sale. The information could also include whether price drops have been made since the property was offered for sale, and the size and timing of such price drops. The information could also include information about whether the seller initially purchased the property in an up market or a down market period. The information might also include information about reviews of the property that have been written and/or posted online.

The information obtained in step S204 could also include information about any mortgages that the seller has for the property, such as the total amount outstanding, the payment history, the timing of when those mortgages were obtained, and the interest rates of those mortgages. All of this information could be used in step S206 to estimate the ultimate sale price of the property. The information might also include the current interest rates being offered to buyers for the type of property being sold, and any historical record relating to recent changes in interest rates, as well as any predicted future changes in such interest rates.

The information obtained in step S204 could also include information about the number of similar properties that are currently for sale in the surrounding area—in other words the current inventory levels for similar properties. Historical information about the inventory levels, and predictions about the near term future inventory levels may also be obtained and used in step S206 to estimate the ultimate sale price of the property.

Information about weather forecasts may also be obtained in step S204, as this information may be relevant to an estimate about the chance that the property will sell in the near future.

Information about the inventory of properties for sale in the surrounding area may also be taken into account. This information could pertain to all properties for sale, or only those with similar characteristics.

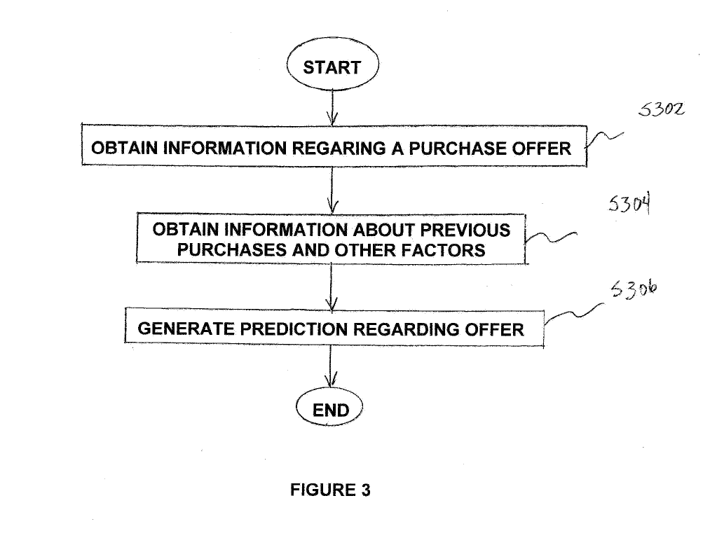

As mentioned above, the sale price estimating system 100 includes an offer analysis unit 112 that is configured to provide a seller with guidance about how to treat a purchase offer from a potential buyer. FIG. 3 illustrates steps of method that would be performed, at least in part, by the offer analysis unit 112.

The method begins in step S302 where information about a potential buyer's purchase is obtained. This can include the sale price of the property and any terms set by the seller, as well as the price offered by the buyer, and any terms set forth in the potential buyer's offer. In step S304, information about previous purchases made by the same potential buyer is obtained. Step S304 could also include obtaining information about other factors. The information about other factors could be the same types of information that was obtained in step S204 of the method illustrated in FIG. 2, as discussed above. This information could be obtained by the offer analysis unit 112, and/or by the data acquisition unit 106 of the sale price estimating system 100.

In addition to the information regarding other factors discussed above, the information obtained in step S304 could include information about the potential buyer. This information could include demographic information about the buyer's characteristics. For example, the information could include the age and occupation of the potential buyer, the buyer's annual income, the buyer's net worth, and other information about the buyer's financial condition. The information could also include the buyer's relationship status, ethnicity, or other distinguishing information. Virtually any information regarding the buyer might be obtained in step S304 and used in step S306. All of this information could be indicative of how the buyer will react during negotiations surrounding the sale of the property, and thus may provide insight regarding the ultimate sale price of the property that the buyer is willing to pay.

In step S306, the offer analysis unit provides information to the seller to help the seller determine how to react to the potential buyer's purchase offer. Information about previous purchases made by the same buyer may provide insight into whether the buyer would be willing to pay more than is currently being offered, as well as insight into what terms, if any, the buyer is willing to negotiate over. The information about the buyer himself may also provide insight into whether the buyer is able to afford to make the purchase, and what level of risk the buyer may be taking by making such a purchase. These and other factors are taken into consideration in providing information and guidance to the seller about how the treat the buyer's offer.

In step S306 the system could provide a report with a list of statistical chances for different outcomes. For example, the report might state that a particular buyer, based on their purchasing background or other factors, might have a 60% chance of accepting a counter offer at a certain price, a 20% chance of countering and a 20% chance of terminating negotiations. The seller will determine what level of risk the seller is willing to take as a next step in negotiations. The report could also offer several price points and outline the statistical odds for each price point for a counter-offer. The report could also merge the buyer's agent's track record with that of the buyer himself. The system could also compare the seller's ultimate expected sale price, from the system 100, to the counter offer recommendations to help determine if the seller is better off waiting for another offer, and what percentage chance the seller has for making more money waiting for another buyer.

As explained above, the sale price estimating unit 110 utilizes a variety of items of information to generate an estimate of the ultimate sale price of a property. One of the items of information is the listing price set by the seller and the listing agent. The listing price is particularly relevant because it is set by the individuals who likely have the most information about the myriad of factors which make the property unique, potentially desirable, and/or potentially undesirable.

It would also be advantageous to obtain information from other knowledgeable individuals about what those individuals believe is an appropriate sale price for the property. While those other individuals may not have as much information about the property, the other individuals may have a better sense of the current market, or the market in which the property is located.

One way of obtaining information from other knowledgeable individuals is to conduct competitions. A competition can be implemented where real estate agents or others guess about what one or more properties will sell for. A series of such competitions could be conducted on a regular basis for multiple properties that are being offered for sale. The participant's guesses can be tracked against the ultimate sale prices for the properties. In this manner, it is possible to build a historical record of how accurate each individual is in guessing the ultimate sale prices for properties.

An individual's record of accuracy could include an overall record for all guesses, as well as records for certain types of guesses. For example, it may be possible to compile separate records of an individual's level of accuracy for different types of properties. Likewise, it may be possible to compile separate records of an individual's level of accuracy for properties in different locations.

If some individuals have demonstrated an ability to accurately guess what properties will sell for, this information can be taken into account by the sale price estimating unit 110 and the offer analysis unit 112 when they generate results for buyers and sellers. Because individuals may generate different records of accuracy for different types of properties and/or properties in different areas or price points, each individual's guess about the sale price may or may not be worth considering. For example, if a certain individual has demonstrated a high degree of accuracy for the sale prices of townhomes, but not for condominiums, and if the property in question is a condominium, that person's estimate would not likely be taken into account. On the other hand, if the property in question is a townhome, it would make sense to take that individual's estimate into account.

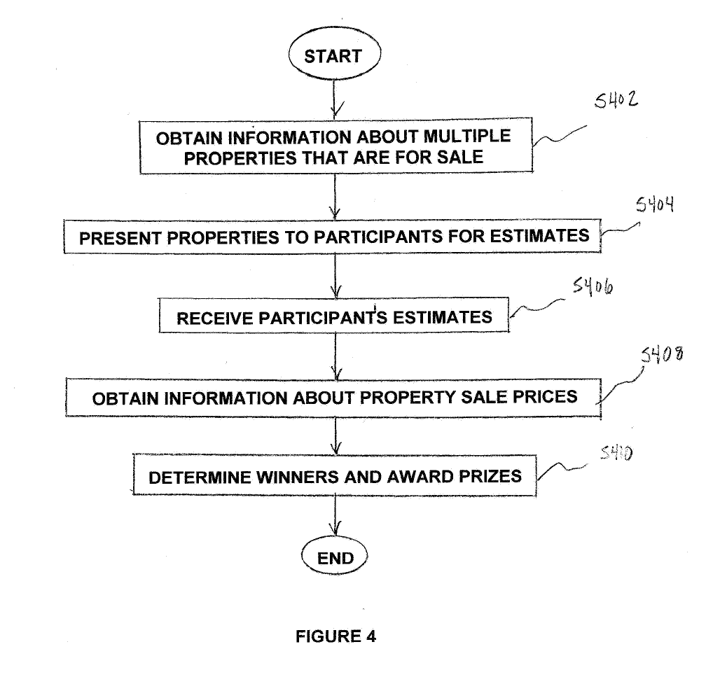

FIG. 4 illustrates steps of a method of conducting a competition to obtain information from individuals about estimated sales prices for properties. This method would be performed by the sale price competition unit 114 of the sale price estimating system 100 illustrated in FIG. 1.

The method begins in step S402, where the sale price competition unit 114 obtains information about multiple properties that are for sale. This information could be obtained by the sale price competition unit 114 and/or by the data acquisition unit 106. In step S404, information about the properties would be presented to participants so that the participants can provide input regarding the estimated sale prices of the properties. In some instances, the participants would be asked to estimate the price at which the property will ultimately sell. In other instances, the participant may be informed of the list price, and the participant will be asked to indicate if the list price is too high, too low, or approximately correct. In still other instances, the participant may be asked to provide what they view as appropriate list prices for properties and what they view as the likely sales prices for the properties. Those estimates could be a set amount, or they could be expressed as a range.

In step S406, the sale price competition unit will obtain the estimates or information provided by the participants. In step S408, the sale price competition unit would obtain information about the ultimate sale prices for the properties as those sales are made. Finally, in step S410, the sale price competition unit would determine which participants provided the most accurate estimates or information. Step S410 could also include declaring the winners of the competition and awarding prizes to those winners. In some instances, simply being named as one of the most accurate participants may be a sufficient inducement to participate. For example, real estate agents would likely wish to participate, provided they can achieve good results, simply to demonstrate that they are knowledgeable about the market. In other instances, it may be necessary to award some form of a prize to induce individuals to participate in the competitions.

As noted above, the sale price competition unit would track the accurate of the individual participants over time to identify those participants who provide accurate estimates. Once the accurate individuals are identified, their guesses about the sales prices of properties would be taken into account by the sale price estimating unit 110 and the offer analysis unit 112.

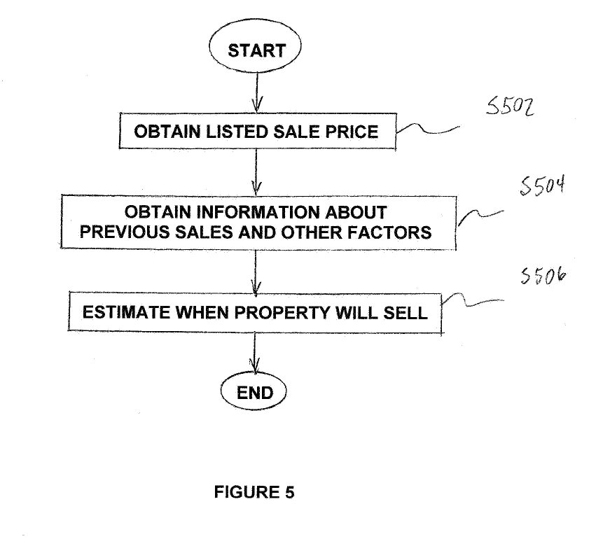

As mentioned above, the sale price estimating unit 110 may be configured to calculate and provide estimates regarding the timing of the sale of a property. A method of generating such estimates is illustrated in FIG. 5.

The method begins in step S502, where information about the listed sale price of a property is obtained. In step S504, information about previous sales and information on other factors is obtained. This information could be any of the items of information discussed above regarding the property, the seller, the agent representing the seller, as well as other information. This information could be obtained by the sale price estimating unit 110 and/or the data acquisition unit 106. Finally, in step S506, the sale price estimating unit 110 generates an estimate regarding when the sale of the property will likely occur.

The information that is obtained may include information about the number of days that other properties have remained on the market before being sold. This information could relate to all properties, or only those with similar characteristics. This information could be limited to only properties that were sold by the same listing agent, only properties sold by the firm that employs the listing agent, or all sales by all listing agents.

The estimate provided in step S506 could be an estimate of the day, week or month in which the sale is likely to occur. The estimate could also be in the form of a percentage chance that the sale will occur within a predetermined period of time. For example, the estimate could indicate that there is an 80% chance that the sale will occur within the next month.

An estimate regarding when a sale is likely to occur could be used by buyers to determine when to make an offer on a property. For example, if a buyer is interested in a particular property, but is still looking at other potential properties and is undecided, this information could be used to determine when to make an offer on the property. If the estimate indicates that a sale is not likely to occur in the near future, the buyer might wait to make an offer while the buyer continues to search for alternate properties. However, over time, the chances of a sale occurring will gradually rise. Once it becomes clear that a sale to some other party is likely to occur in the near future, the buyer may choose to discontinue the search for alternate properties and to go ahead and make an offer. Furthermore, waiting weeks or a month to make an offer might increase the buyer's chance for winning the property with a lower offer, if the calculation shows that the longer the property does not sell, the lower the final price will likely be.

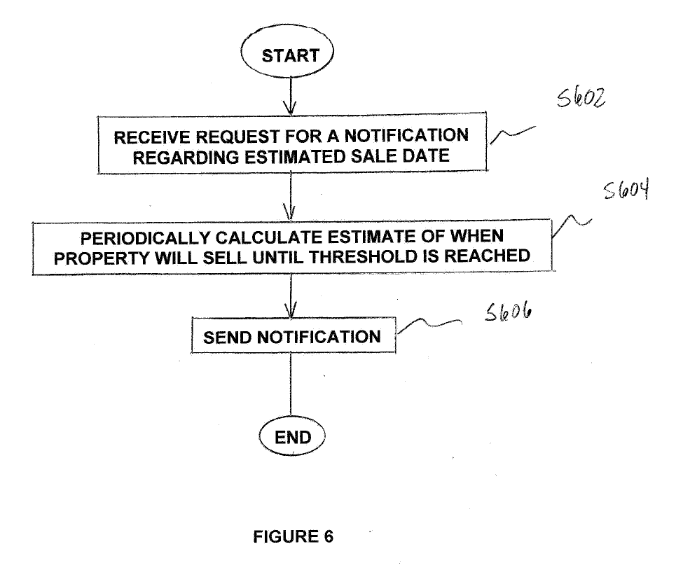

FIG. 6 illustrates steps of a method that could be performed, at least in part, by the user notification unit 116 of the sale price estimating system 100. This method would be used to provide notifications to potential buyers about the likelihood that a particular property will sell in the near future.

The method begins in step S602, where a request for a notification is received from a user. The request would be for a notification regarding an estimate of when a property is likely to sell. For example, a user could request that he be provided with notification when there is a 50% chance that a particular property will sell within the next month. A user could lodge a request for a notification in multiple different ways. In some instances, a user could utilize a website interface to make a request. In other instances, the user could utilize an application running on or through a mobile computing device to make a request. In other instances, an interactive voice response system could be accessed via telephone. The present technology is intended to encompass any method of lodging such a request.

Next, in step S604, estimates of when the property will sell are calculated on a periodic basis. This calculation could be performed in accordance with the method illustrated in FIG. 5, as discussed above. After each calculation is performed, the resulting likelihood of a sale occurring is compared to the threshold listed in the user's request. For example, if the user requested that he be provided with a notification when there is a 50% or greater likelihood of a sale occurring within the next month, the calculation would be for the likelihood of a sale occurring within the next month, and the resulting estimate is compared to the 50% threshold stated by the user. The estimate is periodically performed until the calculated result exceeds the stated threshold. Once the calculated result exceeds the threshold, the method proceeds to step S606, where a notification is sent to the user.

The request for a notification could vary in many different ways. The actual percentage specified as the threshold could vary. Also, the period for which the likelihood of a sale pertains could vary. For example, a user could request a notification when there is a 50% chance of a sale occurring in one month, or the user could request a notification when there is a 50% chance of a sale occurring in one week. Or, the user could request both notifications.

The sale price estimating system 100 described above can be self-updating and evolving to look for other patterns so that it can become more and more accurate in providing estimates. One way is to watch online user habits. For example, if a particular home is viewed more frequently or “watched/saved” more frequently than other homes, it might show a tendency to sell for higher or lower than the current forecast. This data, if found to be statistically relevant, can be used to adjust the estimates provided by the system.

The sale price estimating system 100 can be used as a tool to provide buyers, sellers, their agents, and interested third parties with useful information about anticipated sale prices and the anticipated timing of sales. The system could be embedded in a database search tool that allows buyers to search for homes based on anticipated sale prices, rather than listing prices. This is significant, because searching based on the anticipated sale price of a home is likely to provide more meaningful results than searches based on list price. For example, a buyer who knows he can afford to purchase a home costing $500,000 would likely conduct a search using that price, and thereby miss homes listed for $525,000, even though the anticipated sale price for that home might be $475,000. If the buyer instead conducts searches based on the anticipated sale price, the buyer will obtain more relevant search results, including the home listed for $525,000.

Websites that utilize estimates provided by the sale price estimating system will enjoy the ability to show the predicted sale price, in addition to list price. It is generally accepted that the longer a property remains on the market unsold, the lower the actual sales price will be when the property ultimately sells. As noted above, the sale price estimating system 100 calculates the estimated sales price for a property if the property were to sell today. This feature can also be used to display a real-time price for a property. And because the price tends to go down over time, that real-time price can show the number gradually ticking down over time. Thus, an online listing for a property can include a present “sales price” that visibly adjusts downward each minute or second.

The embodiments illustrated and discussed above are in no way exhaustive and are not intended to be limiting. Any other methods of determining the sale price and estimate sale date of a property would also be encompassed by the disclosed technology.

The terminology used herein is for the purpose of describing particular embodiments only and is not intended to be limiting of the disclosed technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the disclosed technology has been described in connection with what is presently considered to be the most practical and preferred embodiment, it is to be understood that the disclosed technology is not to be limited to the disclosed embodiment, but on the contrary, is intended to cover various modifications and equivalent arrangements included within the spirit and scope of the appended claims.

What is claimed is:

1. A method of estimating the sale price of a property, comprising:
obtaining the current listed sale price;
acquiring information about previous sales made by at least one of the seller, an agent representing the seller, and a firm representing the seller; and
determining an estimated sale price for the property based on the current list price and the acquired information.

2. The method of claim 1, wherein the acquiring step comprises acquiring information about the original list price and the ultimate sale price for previous sales made by at least one of the seller, an agent representing the seller and a firm representing the seller.

3. The method of claim 2, wherein the property is real estate, and wherein the information acquired about the original list price and the ultimate sale price for previous sales are for previous sales made by the agent or firm representing the seller for real estate in the same area as the property.

4. The method of claim 2, wherein the acquired information relates to previous sales made by the agent or firm representing the seller, and wherein the acquired information further includes the time that elapsed between listing and sale for previous sales made by the agent or firm.

5. The method of claim 2, wherein the acquired information includes information about the original list price and the ultimate sale price for previous sales made by the seller and information about the original list price and the ultimate sale price for previous sales made by the agent or firm representing the seller.

6. The method of claim 5, wherein during the determining step, the information about the original list price and the ultimate sale price for previous sales made by the seller is weighted differently from the information about the original list price and the ultimate sale price for previous sales made by the agent or firm representing the seller.

7. The method of claim 2, wherein the acquired information also includes information regarding a number of previous sales made by at least one of the seller, an agent representing the seller and a firm representing the seller.

8. The method of claim 2, further comprising obtaining information about the agent's level of professional sales experience, and wherein the estimated sale price for the property is also based on the obtained information about the agent's level of professional sales experience.

9. The method of claim 2, further comprising obtaining information about personal characteristics of the seller, and wherein the estimated sale price for the property is also based on the obtained information about the personal characteristics of the seller.

10. The method of claim 2, further comprising obtaining information about at least one of a size and a timing of any drops in the listed sale price of the property which have occurred since the property was first offered for sale, and wherein the estimated sale price for the property is also based on the obtained information about at least one of the size and the timing of any drops in the listed sale price of the property.

11. The method of claim 1, further comprising periodically re-determining an estimated sale price for the property and providing the updated sale price.

12. The method of claim 1, wherein the determining step comprises determining an estimated sale price for the property when it ultimately sells.

13. The method of claim 1, wherein the determining step comprises determining an estimated sale price for the property if it sold today.

14. A non-transitory computer readable medium storing instructions which, when executed by one or more computer processors, cause the one or more computer processors to perform a method of estimating the sale price of a property, comprising:
obtaining the current listed sale price;
acquiring information about previous sales made by at least one of the seller, an agent representing the seller and a firm representing the seller; and
determining an estimated sale price for the property based on the current list price and the acquired information.

15. The non-transitory computer readable medium of claim 14, wherein the instructions also cause the one or more computer processors to perform the acquiring step such that information about the original list price and the ultimate sale price for previous sales made by at least one of the seller, an agent representing the seller and a firm representing the seller is acquired.

16. The non-transitory computer readable medium of claim 15, wherein the property is real estate, and wherein the information acquired about the original list price and the ultimate sale price for previous sales are for previous sales made by the agent or the firm representing the seller for real estate in the same area as the property.

17. The non-transitory computer readable medium of claim 15, wherein the acquired information relates to previous sales made by the agent or firm representing the seller, and wherein the acquired information further includes the time that elapsed between listing and sale for previous sales made by the agent or firm representing the seller.

18. The non-transitory computer readable medium of claim 15, wherein the acquired information includes information about the original list price and the ultimate sale price for previous sales made by the seller and information about the original list price and the ultimate sale price for previous sales made by the agent or firm representing the seller.

19. The non-transitory computer readable medium of claim 15, wherein the instructions also cause the one or more computer processors to obtain information about the agent's level of professional sales experience, and wherein the estimated sale price for the property is also based on the obtained information about the agent's level of professional sales experience.

20. The non-transitory computer readable medium of claim 15, wherein the instructions also cause the one or more computer processors to perform the determining step such that an estimated sale price for the property if it sold today is determined.
